(19) United States
(12) Patent Application Publication
(10) Pub. No.: US 2026/0211199 A1
(43) Pub. Date: Jul. 23, 2026

(54) DISPLAY DEVICE

(71) Applicant: LG ELECTRONICS INC., Seoul (KR)

(72) Inventors: Nayoung JO, Seoul (KR); Wonsuk LIM, Seoul (KR)

(73) Assignee: LG ELECTRONICS INC., Seoul (KR)

(21) Appl. No.: 19/275,470

(22) Filed: Jul. 21, 2025

(30) Foreign Application Priority Data
Jan. 23, 2025 (WO) PCT/KR2025/001286

(51) Int. Cl. G02B 6/42; G01J 1/42; H04N 21/422

(52) U.S. Cl. CPC G02B 6/4298; G01J 1/42; G02B 6/424; H04N 21/42221

(57) ABSTRACT

Disclosed herein is a display device including a display panel, a main board mounted on a rear surface of the display panel, an infrared receiver mounted on the main board and facing downward, and a light guide extending from a lower end of the display panel to a lower portion of the infrared receiver, the light guide comprising a light-transmissive material, wherein the light guide includes a light incidence surface disposed at the lower end of the display panel, and a light exit surface facing the infrared receiver.

### CROSS-REFERENCE TO RELATED APPLICATION(S)

Pursuant to 35 U.S.C. § 119, this application claims the benefit of earlier filing date and right of priority of International Application No. PCT/KR2025/001286, filed on Jan. 23, 2025, the contents of which are all incorporated by reference herein in their entirety.

### BACKGROUND

### Field

The present disclosure relates to a display device having a design that makes an infrared receiver configured to receive signals from a remote control unexposed to the outside.

### Discussion of the Related Art

With growth of information society, demand for various display devices has increased. In order to satisfy such demand, in recent years, a liquid crystal display (LCD), a field emission display (FED), a plasma display panel (PDP), and an electroluminescent device have been developed as display devices.

A liquid crystal panel of the liquid crystal display includes a liquid crystal layer and a TFT substrate and a color filter substrate opposite each other in the state in which the liquid crystal layer is interposed therebetween, wherein a picture is displayed using light provided from a backlight unit.

An active matrix type organic light-emitting display has come onto the market as an example of the electroluminescent device. Since the organic light-emitting display is self-emissive, the organic light-emitting display has no backlight, compared to the liquid crystal display, and has merits in terms of response time and viewing angle, and therefore the organic light-emitting display has attracted attention as a next-generation display.

Recently, materials such as OLEDs, which are self-illuminating without a backlighting structure on the backside, have allowed for the realization of bendable display modules, enabling the realization of curved display devices.

Not only are displays becoming thinner, but the size of the non-display region surrounding the display region of the display is also decreasing. As the size of the case that encloses the display decreases and the bezel which includes the non-display region and the case surrounding the front perimeter becomes less than 1 cm, bezel-less display devices are becoming mainstream.

In addition, recent display devices may include antennas and wireless signal receivers configured to transmit and receive various wireless signals, in addition to performing wired communication. A representative example is an infrared receiver that receives signals from a remote control that uses infrared light.

Since remote control signals are provided from a position in front of the display device that outputs images, the remote control receiver should be disposed facing forward. However, as the bezel of the display panel becomes narrower, there is insufficient space to install the infrared receiver. Thus, conventional display devices have disposed the infrared receiver in a protruding form at the lower portion of the main body.

However, an infrared receiver protruding from the lower portion of the main body is prone to damage during transport, or requires additional protective components to prevent such damage.

### SUMMARY OF THE DISCLOSURE

An object of the present disclosure is to provide a display device that minimizes the protruding structure of the infrared receiver at the lower end of the body of the display device to reduce the risk of damage to the infrared receiver and achieve an excellent design.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a display device may include a display panel, a main board mounted on a rear surface of the display panel, an infrared receiver mounted on the main board and facing downward, and a light guide extending from a lower end of the display panel to a lower portion of the infrared receiver, the light guide comprising a light-transmissive material. The light guide may include a light incidence surface disposed at the lower end of the display panel, and a light exit surface facing the infrared receiver.

The infrared receiver may be disposed at a horizontal center of the light exit surface.

The display device may further include an illuminance sensor mounted on the main board and arranged adjacent to the infrared receiver, wherein the illuminance sensor may be disposed facing the light exit surface of the light guide.

The light guide may include a horizontal guide extending rearward from the light incidence surface, and a vertical guide extending vertically from the light exit surface and connected to the horizontal guide.

A corner at a junction of the horizontal guide and the vertical guide may include an inclined reflective surface.

The display device may further include a case top arranged to cover a perimeter of a front surface of the display panel and a lateral surface of the display panel, wherein the light incidence surface of the light guide may be disposed behind a lower end portion of the case top.

An oblique line extending at 45° from a lower end corner of the case top may contact an upper half of the light incidence surface.

A lower end corner of the case top may include a chamfer connecting a front surface and bottom surface of the case top.

The display device may further include a guide bracket fixing the light guide to the case top.

The display device may further include a power switch mounted on the main board, and a power button formed on the guide bracket and arranged to cover the power switch.

The display device may further include a light emitting diode (LED) lamp mounted on the main board, and an LED guide disposed adjacent to the light guide and extending from the LED lamp to a lower portion of the display panel.

The LED guide may include a light incidence portion disposed below the LED lamp, a bent portion disposed below the light incidence portion and inclined forward, and a light exit portion extending forward from the bent portion, wherein the bent portion may include a first inclined reflective surface inclined forward on a bottom surface thereof.

The bent portion may include a second inclined reflective surface facing away from the first inclined reflective surface.

The display device may further include an opaque guide bracket. The light guide and the LED guide may be fastened to the guide bracket. The guide bracket may cover a lower portion of the LED guide.

A front end of the light guide may include an extension extending laterally to cover a front end of the LED guide.

The display device may further include guide hooks protruding from both sides of the light exit surface of the light guide and inserted into the main board.

According to the present disclosure, a protruding structure is omitted from a lower end of a display device. Accordingly, the risk of damage during transport or use may be reduced and an excellent design may be achieved.

In addition, according to the present disclosure, the display device may sufficiently secure the reception rate of the infrared receiver and the amount of light detected by an illuminance sensor.

Furthermore, according to the present disclosure, the display device may reduce the number of circuit boards by mounting the infrared receiver, illuminance sensor, LED lamp, power button, and the like on the main board.

Moreover, according to the present disclosure, the assembly process of the display device may be simplified by implementing a light guide structure for the infrared receiver, illuminance sensor, and LED lamp, and the power button, as a single assembly.

Additionally, according to the present disclosure, the display device may reduce the variation in the amount of light entering the illuminance sensor, thereby improving the accuracy of the illuminance sensor.

The effects obtainable from the present disclosure are not limited to those mentioned above, and other effects not mentioned will be apparent to one having ordinary skill in the art from the following description.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a front view showing an example of a display device according to the present disclosure;

FIG. 2 is a view showing a part of a lower portion of a main board of the display device according to the present disclosure;

FIG. 3 is a cross-sectional perspective view of the display device according to the present disclosure;

FIG. 4 is a cross-sectional view of the display device according to the present disclosure;

FIG. 5 is a perspective view showing a bottom assembly of the display device according to the present disclosure;

FIG. 6 is an exploded perspective view showing the bottom assembly of the display device according to the present disclosure;

FIG. 7 is a side view of a light guide of the display device according to the present disclosure; and

FIG. 8 is a perspective view showing an LED guide of the bottom assembly of the display device according to the present disclosure.

### DETAILED DESCRIPTION OF THE DISCLOSURE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Meanwhile, an image display device described in this specification is, for example, an intelligent image display device having a computer supporting function in addition to a broadcast reception function, wherein an Internet function may be added while the broadcast reception function is devotedly performed, whereby an interface that is more conveniently used, such as a handwriting type input device, a touchscreen, or a space remote control, may be provided. In addition, the image display device may be connected to the Internet or a computer through support of a wired or wireless Internet function, whereby various functions, such as e-mail, web browsing, banking, or gaming, may be executed. For such various functions, a standardized general-purpose OS may be used.

In the image display device described in the present disclosure, therefore, various applications may be freely added or deleted, for example, on a general-purpose OS kernel, whereby various user friendly functions may be executed. More specifically, the image display device may be a network TV, an Hbb TV, or a smart TV, and is applicable to a smartphone depending on circumstances.

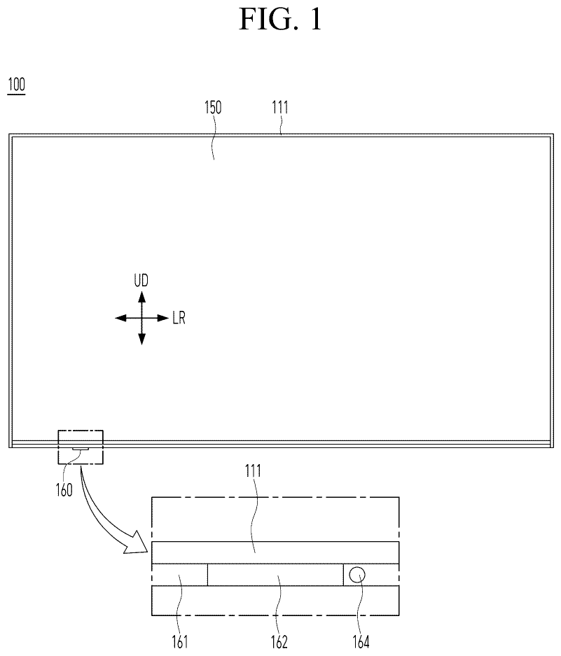

FIG. 1 is a front view showing an example of a display device according to the present disclosure. The display device 100 includes a display panel 150 that occupies most of the area of the front surface, a case top 111 that covers the front perimeter and lateral surface of the display panel 150, and a cover bottom 112 that covers the back.

The display device 100 of the present disclosure may have a rectangular body including a pair of long sides and a pair of short sides. Although the figure illustrates the long sides extending horizontally and the short sides extending vertically, the long and short sides may also have equal lengths, or the long sides may be arranged to extend in the vertical direction.

For simplicity, an embodiment is described where the long sides extend horizontally and the short sides extend vertically. However, as mentioned above, the present disclosure is not limited thereto.

The side of the display device 100 that displays an image may be referred to as the front or front side. When the display device 100 displays an image, the side from which the image cannot be viewed may be referred to as the rear or rear side. When the display device displays an image, the side that does not allow image observation may be referred to as the rear (rearward direction) or rear side (rear surface).

The display panel 150 may convert an image signal, a data signal, an OSD signal, and a control signal processed by the controller 180 or an image signal, a data signal, and a control signal received from the interface unit to generate a driving signal. The display panel 150 may include a display panel having a plurality of pixels.

Each of the plurality of pixels in the display panel may include RGB subpixels. Alternatively, each of the plurality of pixels in the display panel may include RGBW subpixels. The display panel 150 may convert an image signal, a data signal, an OSD signal, and a control signal processed by the controller 180 to generate a driving signal for the plurality of pixels.

A plasma display panel (PDP), a liquid crystal display (LCD), an organic light-emitting diode (OLED), or a flexible display may be used as the display panel 150, and a 3D display may also be used. The 3D display 130 may be classified as a non-glasses type display or a glasses type display.

An organic light-emitting diode (OLED) panel appeared in earnest in mid-2010 and has rapidly replaced the LCD in the small-or medium-sized display market. The OLED is a display manufactured using a self-emissive phenomenon of an organic compound in which the organic compound emits light when current flows in the organic compound. The response time of the OLED is shorter than the response time of the LCD, and therefore afterimages hardly appear when video is implemented.

The OLED is an emissive display product that uses three fluorescent organic compounds having a self-emissive function, such as red, green, and blue fluorescent organic compounds and that uses a phenomenon in which electrons injected at a negative electrode and a positive electrode and particles having positive charges are combined in the organic compounds to emit light, and therefore a backlight unit, which deteriorates color, is not needed.

Since OLEDs do not require a backlight unit, the layer structure thereof is relatively simple. Unlike LCDs, guide panels for aligning each layer are unnecessary, and thus the case structure of the OLEDs is also simple.

The display panel 150 employs organic light-emitting diodes and may have a thin structure as the backlight may not be used. A module cover 120, which supports the rear surface of the display panel 150, may be formed of a metal material to provide sufficient rigidity to support the thin display panel 150. The module cover formed of a metal material may offer excellent heat dissipation performance.

The display panel 150 includes a display region in which multiple pixels are disposed to output an image in by changing the color of each pixel, and a non-display region (bezel) disposed around the display region, where signal lines for signal connection are arranged.

The size of the non-display region may be less than or equal to 1 cm. The non-display region at the lower end portion, where a flexible substrate 158 is disposed to connect to the main board, may be larger than those on the other sides of the perimeter. Since the non-display region does not output images, it may include a black coating layer to cover the signal lines.

The display device 100 may further include a bottom assembly 160 disposed at the lower end of the display device 100. As the size of the bezel of the display device 100 becomes smaller, there is a limitation in arranging components other than the display panel to face forward.

In particular, components such as an infrared receiver configured to receive infrared signals from a remote control and an illuminance sensor configured to measure the amount of light at the front of the display panel should receive light incident from the front.

Conventionally, for a display device 100 having a sufficiently large bezel, the infrared receiver and illuminance sensor are disposed using a portion of the bezel. However, in recent designs, they may be disposed at the lower end portion using a separate bracket.

However, an excessive protrusion of the bottom assembly 160 from the lower end portion of the display device 100 may be a factor that spoils the simple appearance of the display device 100, and cause the bottom assembly 160 to be damaged during transportation or use.

Therefore, for the display device 100 of the present disclosure, the substrate on which the infrared receiver and illuminance sensor are mounted is omitted from the bottom assembly 160 to minimize the size of the bottom assembly 160.

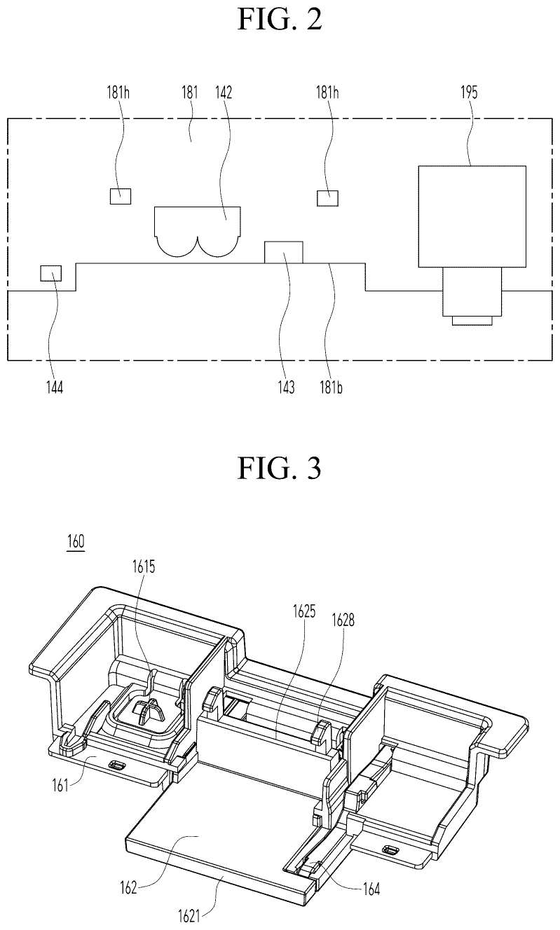

FIG. 2 is a view showing a part of the lower end portion of the main board 181 of the display device 100 of the present disclosure. The lower end portion of the main board 181 is disposed adjacent to the bottom assembly 160. Components such as an infrared receiver 142, an illuminance sensor 143, an LED light source, and a power switch 195 may be disposed at the lower end portion.

Conventionally, the display device 100 may include multiple substrates divided by functions, such as a power board for power distribution, a T-con board for control of the display panel 150, and an optical board disposed to face forward for the infrared receiver 142 and illuminance sensor 143.

For the display device 100 of the present disclosure, the optical board, which is conventionally disposed in the bottom assembly 160, is omitted. Instead, the infrared receiver 142 and illuminance sensor 143 are disposed on the main board 181 mounted on the rear of the display device 100. Thereby, the number of boards and the size of the bottom assembly 160 may be reduced.

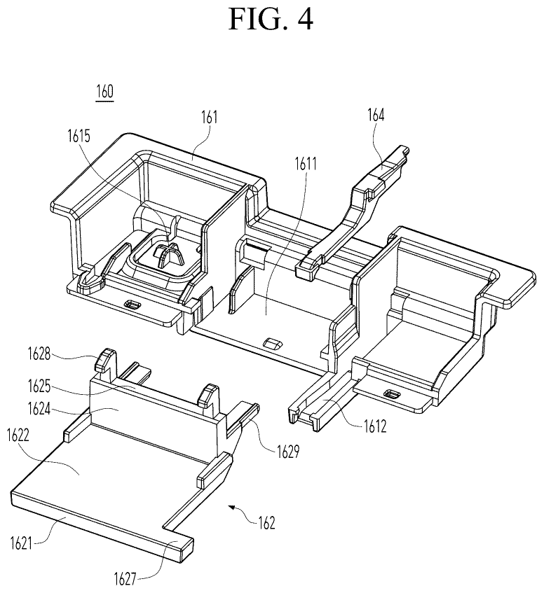

FIG. 3 is a perspective view showing the bottom assembly 160 of the display device 100 according to the present disclosure, and FIG. 4 is an exploded perspective view showing the bottom assembly 160 of the display device 100 according to the present disclosure.

The bottom assembly 160 of the present disclosure may include a light guide 162 having an L shape and formed of a transparent material, a guide bracket 161 configured to hold the light guide 162 seated thereon and coupled to the cover bottom 112, and an LED guide 164 configured to direct the light of the LED light source forward.

The guide bracket 161 may include a first seat 1611 on which the light guide 162 is seated, and a second seat 1612 on which the LED guide 164 is seated. The guide bracket 161 may be fastened to the cover bottom 112. The guide bracket 161 may also include a power button 1615 with an actuator. The power button 1615 may be disposed under the power switch 195 shown in FIG. 2. When the user presses the power button 1615, the power switch 195 may be turned ON/OFF.

To ensure that light is supplied to the infrared receiver 142 and illuminance sensor 143 located on the rear side, the bottom assembly 160 may include the light guide 162. The light guide 162, formed of a transparent material that totally reflects light incident at or above a predetermined angle (threshold angle), may guide infrared signals and light from the front to the infrared receiver 142 and illuminance sensor 143 disposed at the rear.

As shown in FIG. 2, the lower portion of the main board 181 where the infrared receiver 142 and illuminance sensor 143 are mounted may form a step 181b recessed upward to provide a space where the light guide 162 may be disposed.

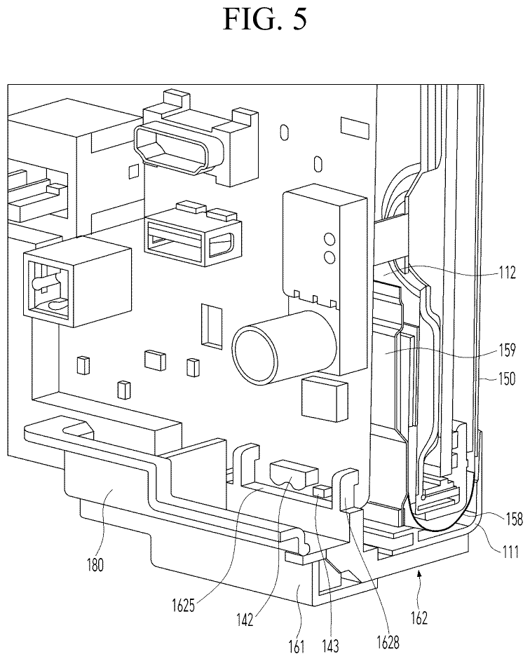

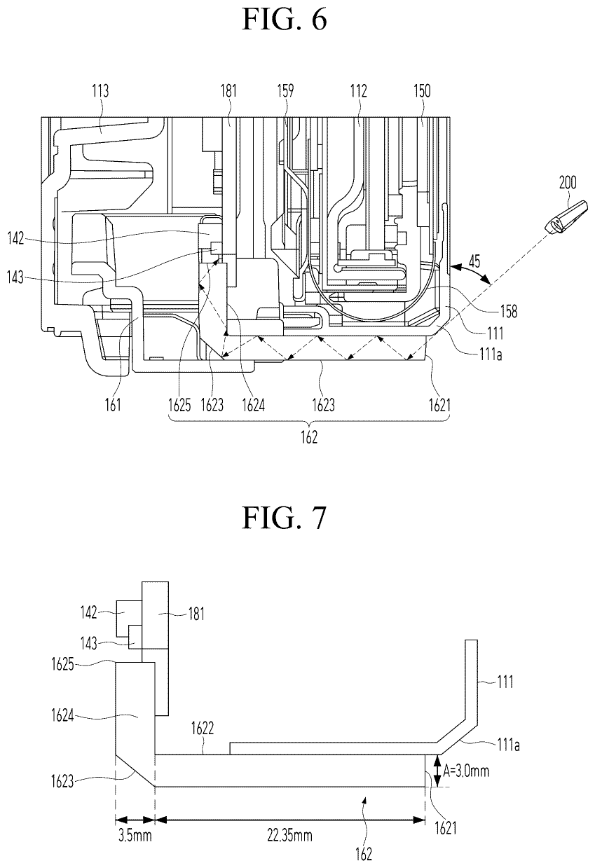

FIG. 5 is a cross-sectional perspective view of the display device 100 according to the present disclosure. The display device 100 may include the display panel 150 disposed at the front, the cover bottom 112 disposed on the rear surface of the display panel 150, the main board 181 mounted on the rear surface of the cover bottom 112, and a back cover 113 (see FIG. 6) that covers the main board 181 and is fastened to the cover bottom 112.

The display device 100 may further include a frame-shaped case top 111 with an L-shaped cross-section that covers the non-display region arranged at the perimeter of the front of the display panel 150 and the sides of the display panel 150.

A flexible substrate 158 that connects to the display panel 150 and extends to the back of the display panel 150 may be provided between the lower end of the display panel 150 and the case top 111. An end portion of the flexible substrate 158 may be connected to a panel substrate that controls the display panel 150. The panel board may be seated at the lower end of the cover bottom 112 on the rear surface of the display panel 150. A panel substrate shield 159 that covers the back of the panel substrate may be further included.

The main board 181 mounted on the rear surface of the cover bottom 112 is connected to the panel substrate to provide pixel control information to the display panel 150. It is also connected to various sensors, a power supply unit, antennas, and the like to handle the overall control of the display device 100.

As described above, conventionally, multiple substrates are arranged separately by function and position, but this increases assembly complexity and manufacturing cost. Therefore, by mounting the infrared receiver 142 and illuminance sensor 143 on the main board 181, the number of substrates may be reduced. The infrared receiver 142 and the illuminance sensor 143 may be disposed to face downward, and an end portion of the vertical guide 1624 of the light guide 162 may be disposed to face the infrared receiver 142 and the illuminance sensor 143.

FIG. 6 is a cross-sectional view of the display device 100 according to the present disclosure. The light guide 162 may have an L-shaped cross-section and may include a horizontal guide 1622 disposed at the lower portion of the display device 100 and a vertical guide 1624 extending upward from the rear end of the horizontal guide 1622.

The front end of the horizontal guide 1622 includes a light incidence surface 1621 on which light from an external light source 200 is incident. The external light source 200 may be an infrared signal emitted from a remote control for controlling the display device 100, or it may be light in the space where the display device 100 is installed.

Light incident on the light incidence surface 1621 is totally internally reflected along the horizontal guide 1622 and transmitted rearward. A reflective surface 1623 positioned between the horizontal guide 1622 and the vertical guide 1624 reflects the light traveling along the horizontal guide 1622 into the vertical guide 1624, where it is totally internally reflected and emitted from a light exit surface 1625 arranged at the upper end of the vertical guide 1624.

The light exit surface 1625 of the vertical guide 1624 may be disposed facing the infrared receiver 142 and illuminance sensor 143, which face downward. The infrared receiver 142 may receive the infrared signal and recognize user input entered on the remote control. The illuminance sensor 143 may measure the amount of light incident through the light guide 162.

The light guide 162 may include guide hooks 1628 disposed on both sides of the light exit surface 1625 to fix the position of the light guide 162 on the main board 181. The main board 181 may include a pair of hook holes 181h positioned on both sides of the infrared receiver 142 and the illuminance sensor 143.

The light guide 162 may further include a fastening protrusion 1629 extending rearward from the vertical guide 1624 to fasten the light guide 162 to the guide bracket 161. The fastening protrusion 1629 may be disposed to correspond to the positions of the guide hooks and does not substantially affect the amount of light delivered to the infrared receiver 142 and the illuminance sensor 143.

As the light incidence surface 1621 protrudes further forward, it is easier for light to be incident. However, it affects the appearance of the display device 100 and increases the risk of damage. For this reason, the light incidence surface 1621 may be disposed behind the front of the case top 111.

Assuming that light emitted from indoor lighting is incident at a 45° angle, the position of the light incidence surface 1621 may be arranged such that a line extending at 45° from the lower edge of the case top 111 is positioned at the upper half of the light incidence surface 1621.

The edge of the case top 111 may be provided with a chamfer 111a as shown in FIG. 5. The position of the light incidence surface 1621 may be disposed further back from the front of the display device 100 by means of the chamfer 111a.

The reflective surface 1623 may be arranged at an angle of 45° and reflect light transmitted through the horizontal guide 1622 into the vertical guide 1624. Light emitted from the light exit surface 1625 at the upper end portion of the vertical guide 1624 may be supplied to the infrared receiver 142 and the illuminance sensor 143. The infrared receiver 142 may be disposed at the horizontal center of the light exit surface 1625 of the light guide 162 so as to recognize signals incident at various angles.

FIG. 7 is a side view of the light guide 162 of the display device 100 according to the present disclosure. It shows only the light guide 162, infrared receiver 142, illuminance sensor 143, substrate, and case top 111 in FIG. 6. As described above, the light incidence surface 1621 of the light guide 162 may be arranged such that oblique extension at 45° from the lower edge of the case top 111 contacts the upper half of the light incidence surface 1621.

Since the vertical guide 1624 is positioned below the infrared receiver 142 and the illuminance sensor 143, the length of the horizontal guide 1622 may be the distance from the light incidence surface 1621 to the position of the vertical guide 1624. If the light incidence surface 1621 protrudes further forward, the area exposed to the user's view increases. Accordingly, the light incidence surface 1621 may be disposed slightly behind the edge of the case top 111.

As the width of the light incidence surface 1621 (along the vertical direction in the drawing) increases, the degree of exposure of the light incidence surface 1621 to the outside increases. Also, if the light incidence surface 1621 is disposed further behind the edge of the case top 111, the reception rate of the infrared signal decreases. Therefore, the light incidence surface 1621 of the light guide 142 according to the present disclosure may be configured to have a width of 3 mm.

The width of the light exit surface 1625 (along the horizontal direction in the drawing) may be configured to cover the infrared receiver 142 to increase the reception rate. However, if the light exit surface 1625 is formed excessively large compared to the infrared receiver 142, the reception rate of infrared signals incident at an angle from the side may not meet the standard.

Therefore, the light exit surface 1625 may have a width corresponding to that of the infrared receiver 142. Considering the tolerance that may occur when installing the light guide 162 on the main board 181, the size of the light exit surface 1625 may be equal to or up to 0.5 mm greater than the thickness of the infrared receiver 142. In this embodiment, the size of the light exit surface 1625 may be 3.5 mm, which is greater than the light incidence surface 1621.

The light guide 162 may supply not only infrared signals but also visible light incident on the light incidence surface 1621 to the illuminance sensor 143 to measure the amount of light. The illuminance sensor 143 is disposed adjacent to the infrared receiver 142 and may be disposed to one side of the center of the light exit surface 1625 of the light guide 162. Since the illuminance sensor 143 comprehensively measures light incident from a wide range rather than collimated light incident from a specific direction, the horizontal position of the light exit surface 1625 of the light guide 162 does not significantly affect the performance of the illuminance sensor 143.

The guide bracket 161 may have a first seat 1611 on which the light guide 162 is seated, a second seat 1612 on which the LED guide 164 is seated, and a power button 1615 disposed under the power switch 195. The power button 1615 and the second seat 1612 may be disposed on both sides of the first seat 1611, and the power button 1615 may be arranged to face the bottom of the display device 100.

Since the light guide 162 receives external light, it is wide in the horizontal direction, but the LED guide 164 may be narrow because it is configured to supply light emitted from the LED lamp 144 forward. Therefore, the width of the first seat 1611 may be wide, and the width of the second seat 1612 may be narrow.

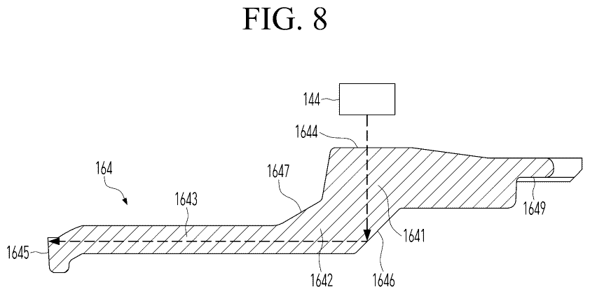

FIG. 8 is a perspective view showing the LED lamp 144 of the display device 100 and the LED guide 164 of the bottom assembly 160 according to the present disclosure. The LED lamp 144 is a device to indicate the status of the display device 100, and may indicate the ON/OFF status of the power or a fault by changing the color.

The LED guide 164 may include a light incidence portion 1641 disposed below the LED lamp 144, a bent portion 1642 inclined forward from a lower portion of the light incidence portion 1641, and a light exit portion 1643 extending forward from the bent portion 1642. The LED guide 164 is arranged in the opposite direction to the light guide 162 in terms of the light path, and the light incidence portion 1641 allows the light of the LED lamp 144 incident on the light incidence surface 1644, which is the top surface of the light incidence portion 1641, to be transmitted downward in the vertical direction.

The LED guide 164 delivers the light of the LED lamp 144. Accordingly, if the LED guide 164 is formed integrally with the light guide 162, the light of the LED lamp 144 may be recognized as external light by the illuminance sensor 143, and the LED light emitted forward may appear blurred due to the diffusion of the light of the LED lamp 144.

Therefore, the bottom assembly 160 of the present disclosure includes the light guide 162 configured to guide light to the infrared receiver 142 and the illuminance sensor 143, and the LED guide 164 configured to emit light from the LED lamp 144, individually. The guide bracket 161 partitions the first seat 1611 on which the light guide 162 is seated and the second seat 1612 on which the LED guide 164 is seated, such that the light of the LED lamp 144 does not affect the illuminance sensor 143.

The bent portion 1642 includes a first inclined reflective surface 1646 inclined forward on the bottom surface thereof. The first inclined reflective surface 1646 may be inclined at 45° such that light reflected by the first inclined reflective surface 1646 may travel in the horizontal direction. The LED guide 164 may also be formed of a transparent material. It may be formed of the same material as the light guide 162 or a different material.

Except for the first inclined reflective surface 1646, the other part of the LED guide 164 may reflect a small amount of light and may have a right-angle light path, as shown in FIG. 8. Therefore, unlike the light guide 162, which utilizes total internal reflection, the LED guide 164 may be formed of a material, considering the straightness of light.

Since the light emitted from the LED lamp 144 may spread at a predetermined angle, part of the light may be reflected. A second inclined reflective surface 1647 facing away from the first inclined reflective surface 1646 may be provided to guide the reflected light to move forward along the light exit portion 1643.

To fix the LED guide 164 to the guide bracket 161, a fixing portion 1649 protruding rearward from the light incidence portion 1641 may be further included. It is disposed above the first inclined reflective surface 1646, and thus almost no light from the LED lamp 144 enters the fixing portion 1649.

Referring to FIG. 4, the second guide may have a shape that covers the lower portion of the light exit portion 1643 of the LED guide 164. If the LED guide 164 is exposed downward, light may be reflected on the floor or a cabinet below the display device 100. To address this issue, the guide bracket 161 may cover the lower portion of the LED guide 164.

As shown in FIG. 3, the light guide 162 may have an extension portion 1627 extending laterally to cover the light exit surface 1645 of the LED guide 164. The extension portion 1627 may be on the same plane as the light incidence surface 1621 of the light guide 162.

Through the extension portion 1627 of the light guide 162, the most protruding part exposed to the user at the front of the bottom assembly 160 may be configured as a single member, thereby simplifying the appearance.

In addition, an infrared signal incident on the front of the LED guide 164 may also be transmitted to the infrared receiver 142 through the light guide 162. Accordingly, the reception rate of the infrared receiver 142 may be improved.

Further, the extension portion 1627 of the light guide 162 may fix the position of the front of the LED guide 164.

As described above, by omitting the protruding structure at the lower end, the display device of the present disclosure may reduce damage during transport or use and provide an excellent design.

In addition, the display device 100 of the present disclosure may sufficiently secure the reception rate of the infrared receiver 142 and the amount of light detected by the illuminance sensor 143.

Further, the display device 100 of the present disclosure may reduce the number of boards by mounting the infrared receiver 142, illuminance sensor 143, LED lamp 144, and power button 1615 on the main board 181.

Furthermore, the display device 100 of the present disclosure may simplify the assembly process by implementing the structure of the light guide 162 for the infrared receiver 142, the illuminance sensor 143, and the LED lamp 144, and the power button 1615 as a single assembly.

The above embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A display device comprising:
a display panel;
a main board mounted on a rear surface of the display panel;
an infrared receiver mounted on the main board and facing downward; and
a light guide extending from a lower end of the display panel to a lower portion of the infrared receiver, the light guide comprising a light-transmissive material,
wherein the light guide comprises:
a light incidence surface disposed at the lower end of the display panel; and
a light exit surface facing the infrared receiver.

2. The display device according to claim 1, wherein the infrared receiver is disposed at a horizontal center of the light exit surface.

3. The display device according to claim 1, further comprising:
an illuminance sensor mounted on the main board and arranged adjacent to the infrared receiver,
wherein the illuminance sensor is disposed facing the light exit surface of the light guide.

4. The display device according to claim 1, wherein the light guide comprises:
a horizontal guide extending rearward from the light incidence surface; and
a vertical guide extending vertically from the light exit surface and connected to the horizontal guide.

5. The display device according to claim 2, wherein a corner at a junction of the horizontal guide and the vertical guide comprises an inclined reflective surface.

6. The display device according to claim 1, further comprising:
a case top arranged to cover a perimeter of a front surface of the display panel and a lateral surface of the display panel,
wherein the light incidence surface of the light guide is disposed behind a lower end portion of the case top.

7. The display device according to claim 6, wherein an oblique line extending at 45° from a lower end corner of the case top contacts an upper half of the light incidence surface.

8. The display device according to claim 6, wherein a lower end corner of the case top comprises a chamfer connecting a front surface and bottom surface of the case top.

9. The display device according to claim 6, further comprising:
a guide bracket fixing the light guide to the case top.

10. The display device according to claim 9, further comprising:
a power switch mounted on the main board; and
a power button formed on the guide bracket and arranged to cover the power switch.

11. The display device according to claim 1, further comprising:
a light emitting diode (LED) lamp mounted on the main board; and
an LED guide disposed adjacent to the light guide and extending from the LED lamp to a lower portion of the display panel.

12. The display device according to claim 11, wherein the LED guide comprises:
a light incidence portion disposed below the LED lamp;
a bent portion disposed below the light incidence portion and inclined forward; and
a light exit portion extending forward from the bent portion,
wherein the bent portion comprises a first inclined reflective surface inclined forward on a bottom surface thereof.

13. The display device according to claim 12, wherein the bent portion comprises a second inclined reflective surface facing away from the first inclined reflective surface.

14. The display device according to claim 11, further comprising:
an opaque guide bracket, wherein the light guide and the LED guide are fastened to the guide bracket,
wherein the guide bracket covers a lower portion of the LED guide.

15. The display device according to claim 11, wherein a front end of the light guide comprises an extension extending laterally to cover a front end of the LED guide.

16. The display device according to claim 1, further comprising:
guide hooks protruding from both sides of the light exit surface of the light guide and inserted into the main board.
